(19) United States
(12) Patent Application Publication
(10) Pub. No.: US 2011/0284093 A1
(43) Pub. Date: Nov. 24, 2011

(54) Method for controlling a jigging machine

(75) Inventors: Michael Twitting, Herdecke (DE); Hans-Peter Patryas, Recklinghausen (DE); Juergen Juranek, Essen (DE)

(73) Assignee: MBE Coal & Minerals Technology GmbH, Cologne (DE)

(21) Appl. No.: 13/066,810

(22) Filed: Apr. 26, 2011

(30) Foreign Application Priority Data
Apr. 27, 2010 (DE) 10 2010 018 976.6

(51) Int. Cl. F15D 1/00

(52) U.S. Cl. 137/14

(57) ABSTRACT

A method for controlling the liquid stroke of a pneumatically driven jigging machine for the separation of mineral mixtures uses a jigging machine that consists of an air chamber and a jigging chamber with a jigging bed located above it. The stroke of the liquid in the jigging machine depends on the period of time the air is allowed into the chamber. The differential pressure between the air chamber and the jigging chamber as parameter for controlling the jigging machine is measured, and as a result, a much better opportunity for controlling will be achieved, and disruptions in the jigging bed are detected and can be counteracted.

### CROSS REFERENCE TO RELATED APPLICATIONS

Applicants claim priority under 35 U.S.C. 119 of German Application No. 10 2010 018 976.6 filed Apr. 27, 2010.

### BACKGROUND OF THE INVENTION

The invention is for a method for controlling the liquid stroke of a pneumatically driven jigging machine for the separation of mineral mixtures. The jigging machine consists of an air chamber and a jigging machine with a jigging bed located above it. The stroke of the liquid in the jigging machine depends on the period of time the air is allowed into the chamber.

As a rule, jigging machines are used to separate broken, mixtures of minerals, for instance, coal from mine waste or iron ore from impurities; these machines separate the individual substances from one another with the aid of a regularly changing level of liquids in a jigging bed. To accomplish this, the mixture is fed into a tank in which the water level varies with a frequency of 1 Hz and a stroke of several centimeters up to a maximum of ca. 50 is injected thereby. With the fast variation of the water level, such particles that have a lower density than the average density of the material are raised to the top with the water as the water level rises and when the water level falls, those particles that have a higher density drop faster. A long as the mixture to be separated is in motion in the jigging bed, the mixture of substances is physically separated. When the separating water is drained off into various tanks with the aid of separating plates which are placed approximately in the height of the border between the various substance fractions a division of the mixture of substances according to density is possible.

Such jigging machines are generally adjusted for a certain mixture of substances as the substance separated which in its composition and distribution of particles does not essentially change in the course of a predetermined period of time. Once the jigging machine is set, a separating process generally runs without disturbances when the feed remains consistent. If the composition or the particle size changes or the particle size of the separated substance varies, it is necessary to reset the jigging machine to obtain a consistently optimal separation.

To adjust the stroke and frequency of the water in the jigging chamber, the air inlet time and outlet time are controlled by means of electronic valves. When adjusting the valve times there is generally a frequency variation and a variation of the pulse-pause ratio available, whereby the pulse-pause ratio determines the ratio of the air input time to the air outlet time. An operator of the jigging machine varies this parameter until the jigging machine functions optimally. Control of the function of the jigging machine is performed by observing the motion of the jigging bed.

To avoid a disturbance occurring when sudden changes occur in the composition of the mixture to be separated from that of the original settings, regulators are also used in addition to the time control. The regulators monitor the level of the liquid in the jigging chamber with a measuring system and if the maximum or minimum levels are reached effect a reverse or continuation of the ventilation cycle of the air chamber.

German Patent No. DE 1217292 B describes a float used in the jigging chamber for the purpose of observing the current level of water in the jigging chamber. Due to the fact that the level of the liquid moves with a frequency of ca. 1 Hz, it is not suitable to measure the liquid with a float in the long run, due to the fact that the current level of the water cannot be detected precisely enough within a separating cycle.

For that reason, in German Patent Application DE 24 11 386 C3, a change was made to measuring the water level in the jigging chamber with the aid of capacitive elements which are distributed over the entire height of the jigging chamber or the air chamber. The use of capacitive elements did represent an improvement in measuring the water level in the jigging chamber. Nevertheless, it was desired to monitor the function of the jigging machine more precisely so as to be able to automatically regulate the optimal working parameters during the operation of the jigging machine.

An initial solution was not to measure the water level in the jigging chamber, but rather in the air chamber below the jigging chamber. Due to the fact that the water level in the air chamber, which has a smaller volume than that of the jigging chamber, varies because of the hydraulic principle with the larger stroke than the water level in the jigging chamber and there is free from the measurement of the disruptive separated substance, the water level in the jigging chamber can be determined even better.

However, this method for monitoring the function of a jigging machine did not result in an acceptable monitoring of the function.

The measurement of the water level is subject to a multitude of artifacts in the measurement. An initial source is the oscillations of the water level in the jigging chamber occurring as a result of the resonance oscillations of the water level and that have a higher frequency than the forced stroke of the water in the jigging bed. Along with these regular oscillations, which are not excited when the jigging machine is adjusted optimally, there are also irregular oscillations of the water level in the jigging bed, which are transferred to the height of the water level in the air chamber. These irregular oscillations are generated by a formation of waves in the jigging bed when feeding the substance to be separated.

Additional artifacts can be caused by an oscillation of plates as the chamber wall of the jigging machine, if the water pressure on a metal element also varies as a consequence of the variation in the water level.

Even other artifacts can result from the type of air input and air release or through the vibration of air pressure vessels or machine parts such as disc valves, which have a mass which is no longer negligible for a vibration or by compressors near the jigging machine. Even if the actual forces from external vibrations which impact on the jigging machine are very small compared to the masses of water moved and the substance to be separated being moved, these forces are sufficient to cause undesired vibrations which counteract the consistent rising or falling of the water in the jigging bed desired.

The ideal motion of the water in the jigging bed behaves like a rising and then sinking plane below which the separation of the substance to be separated is occurring. With the state of the art technology, this ideal state is obtained with the optimal adjustment of the jigging machine by trained personnel, whereby the feed rate and the composition as well as the particle size of the substance to be separated ideally does not change or remains within a very small tolerance range. If, however, the feed rate, the composition of the substance to be separated or the size of the particles of the substance to be separated varies in the operation, the speed of the jigging machine decreases due to a less than ideal parameterization.

The challenge is therefore to provide a process for controlling the liquid stroke of a pneumatically driven jigging machine for the separation of mineral mixtures that overcomes the disadvantages of state of the art technology.

### SUMMARY OF THE INVENTION

The challenge on which the invention is based is solved by a method for controlling a jigging machine in which the liquid stroke is controlled by measuring the differential pressure between the pressure in the air chamber and the pressure in the liquid column of the jigging chamber.

Tracking the differential pressure during the jigging cycle allows automatic detection of a malfunction or mis-parameterization of the jigging machine with regard to the mixture to be separated. The signals detected by the measurement of the differential pressure also allow for the distinction of additional artifacts in real-time measurements so that an exact control of the machine is also possible during the cycle. A control with such great precision had not been possible with the parameters applied to date. With the high level of precision the separation rate of a jigging machine can be greatly improved.

Instead of measuring the water level, the invention does not measure the level of the water itself, but rather the differential pressure between the air chamber and the jigging chamber. If the air chamber and the jigging chamber are in hydrostatic equilibrium, the differential pressure is zero. The jigging machine moves, however, a considerable volume of water between the two chambers so that an equilibrium occurs only for a short time within a cycle. The measurement of the difference allows the imbalance between the two chambers to be tracked, which is dominated by the resonance frequency of the vibrating volume of water of the excitation frequency, namely the varying air pressure in the air chamber and the absorption by the friction of the water in the chambers and the dissipation of energy in the separation process. Due to the fact that the water friction of the moving mass of water remains constant, despite the supply and drainage, whereby the mass of water remains in a stationary condition, the excitation frequency is controlled by the controller, the primary influence factor is the dissipation of energy by the separation rate of the jigging machine in the jigging bed. If there is a disruption, this is readily detectable in the development of the differential pressure and a controlling device can counteract disruptions detected on the basis of a disruption control strategy in a control program. Here it is advantageous that the artifacts described above for the most part impact equally on the pressure in the air chamber and the jigging chamber so that the measurement of the differential pressure between the air chamber and the jigging chamber allows for an artifact-free observation of the actual separation process in the jigging bed.

### BRIEF DESCRIPTION OF THE DRAWINGS

The invention is therefore explained in detail in the following illustrations.

These show:

FIG. 1: a schematic drawing of a jigging machine that functions according to the first embodiment of the process,

FIG. 2: a drawing of different states of the jigging bed or a jigging machine

### DETAILED DESCRIPTION OF THE EMBODIMENTS

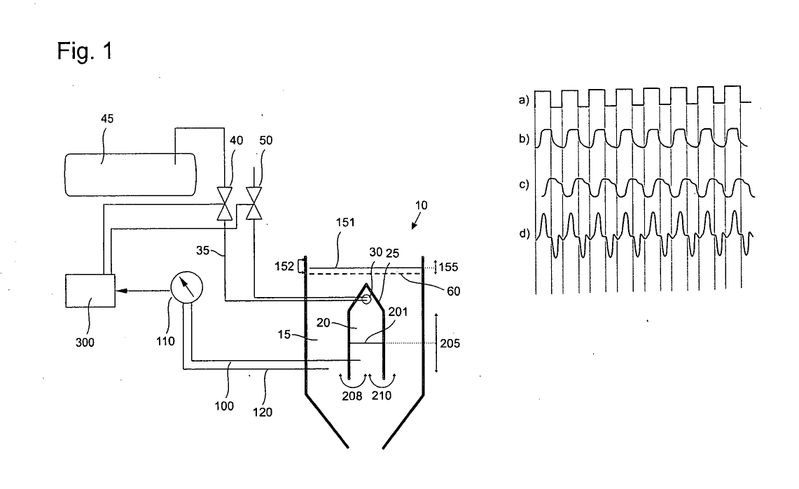

FIG. 1 shows a schematic drawing of a jigging machine 10, which works in accordance with a first embodiment of the process according to the invention. Jigging machine 10 has a jigging chamber 15 and an air chamber 20 separated by a bell-shaped arrangement of metal 25 from the jigging chamber 15, open at the bottom and connected with the jigging chamber 15. When the jigging machine 10 is idle, the jigging chamber 15 and the air chamber 20 are filled with water. When the jigging machine 10 is in operation the air chamber 20 is periodically loaded with pressurized air 30 through an air inlet via a controlled air-pipe 35. An initially operated valve 40 controls the air input from the air-pressure tank, which is constantly filled with pressurized air. Alternating with a second operating valve 50, the air chamber is initially loaded with pressurized air and then vents into the atmosphere via the second operating valve 50. With the renewed loading with pressurized air and venting the upper space of the air chamber 20 is filled and presses the water in the air chamber 20 down into the jigging chamber 15. The water volume from the air chamber 20 raises the level of the liquid 151 in the jigging chamber 15 in the area of the jigging bed 152. With the period loading with air, the water volume described above moves back and forth between the jigging chamber 15 and the air chamber 20. Subsequently the level of the liquid 151 in the area of the jigging bed rises and sinks synchronously with the loading of the air chamber 15 with air pressure. In the area of the jigging bed 152, the jigging chamber 15 is filled above the sieve 60 with the mixture to be separated via slides which are not shown in the illustration. Through the periodic rising and falling of the level of the liquid 151 the less dense material will be transported up in the water volume between the sieve 60 and the level of the liquid 151. In contrast the more dense material sinks in the same volume to the lower part of the water volume near the sieve 60. The water in the jigging bed 152 flows out through drains (not shown) in the top and bottom area of the above mentioned volume of water and removes with it the less dense material in a first run. By contrast the more dense material of the mixture to be separated is removed by the water in the jigging chamber 152 through a second drain (not shown). The water lost through the drain is constantly replaced by the water supply in the lower section of the jigging chamber. Should the volume of water to be replaced be too great, the flow rate in the jigging bed will be too great. The separating rate of the jigging machine will decrease. Should the volume of water flowing in be too small, the material to be separated will be kept in the jigging bed 152 until additional water flows into the drains. The separation rate of the jigging machine 10 is maintained, but the throughput of the jigging machine 10 is less than the optimal rate in this case.

To optimize the separation rate of the jigging machine 10, it is important to adjust both the frequency as well as the pulse-pause ratio of the rising and sinking water level in the jigging bed 152 to the mixture to be separated. When the jigging machine 10 is correctly adjusted, a separation of the less dense and the denser components of the mixture is achieved after only a few cycles. Poorly adjusted air input and release times of the air in the air chamber 20 does not only have an impact on the separation rate and the throughput of the jigging machine 10. With improper adjustment of the jigging machine 10, additional effects can significantly disturb the separation rate of the jigging machine.

An initial consequence of improper adjustment is the formation of a standing water wave in the jigging bed 152. The stabilization of a standing water wave in the jigging bed 152 depends on the frequency of the rising and sinking level of liquid 151 in the jigging bed 152 and the pulse-pause ratio which means that the relative ratio of time within a period in which the level of the liquid 151 stays at the upper maximum and the time of a period in which the level of the liquid stays 151 stays at the lower minimum. An additional factor on which the formation of a standing wave depends is the surface and the length of the edge of the jigging bed 152. If the frequency, pulse-pause ratio and the geometry of the jigging bed match, an undesired standing water wave is formed that counteracts the desired separating effect. In operation, an improper parameterization of the jigging machine, the inflow of material will generally disturb the formation of a standing wave. Nevertheless, the agitation of the level of the liquid 151 an undesired low separation rate will be achieved with improper adjustment. This disturbance occurs relatively frequently in the operation of a jigging machine that is not properly adjusted.

An additional disturbance of the jigging machine is caused by mechanical resonance of the entire system. As a rule, the air chamber and jigging chamber as well as some other aggregates are made of metal that may display a resonance in the Hertz range. If the excitation frequency of the level of the liquid 151 matches the resonance frequency of this metal, a smooth jigging be 152 will also be disturbed, whereby the separation rate will also drop.

But not only too high a frequency or a frequency matching the resonance frequency when raising or lowering the level of the liquid 151 in the jigging bed 151 influences the desired separation rate. The jigging bed 152 may also “die” if the frequency is too low or the pulse-pause ratio too great or too small. This means that the floater, the less dense fraction of the mixture to be separated, drops off and lands on the sinker, the denser fraction of the mixture to be separated. A dead jigging bed 152 has to be rejuvenated by properly adjusting the air times.

Finally, another consequence of improper adjustment is the shooting through of the air if this has forced all the water out of the air chamber 20 and escapes through the jigging chamber 15 out of the air chamber. This agitates the jigging bed 152 and the separation rate of the jigging machine 10 drops rapidly.

To avoid the malfunctions described above, it is foreseen with the invention that the parameters of the air input and air release times are determined automatically and the control of the jigging bed adjusted. This is where the invention takes over. The invention foresees that a differential pressure between the pressure in the air chamber 20 and the pressure of the liquid column of the jigging chamber is measured to monitor the proper function of the jigging machine from the course of the differential pressure, and the jigging machine control is adjusted if a disturbance is detected. The control of the air inlet time is performed depending on the differential pressure measured.

FIG. 1 shows that a first line 100 of a differential pressure meter 110 records the pressure in the jigging chamber 15 and a second line 120 records the pressure in the air chamber. It is intended that in an initial design of the invention, the pressure will be measured in the air chamber 20 in the area of the liquid.

Due to the fact that the volume of the air chamber 15 is much smaller than the volume of the jigging chamber 15, the two chambers 15 and 20 are connected with one another in accordance to the hydraulic principle. A lowering of the level of the liquid 201 in the air chamber 20 results in an increase of the level of the liquid 151 in the jigging bed 152 by a fraction of the height of the stroke of the lowering of the level of the liquid 201 in the air chamber 20. The variation of the level of the liquid 201 in accordance with the double-headed arrow as the stroke 205 is therefore much greater than the stroke 155 as per the double-headed arrow 205. Despite the different levels of the liquid, the pressure in both measuring places in the state of equilibrium of the jigging machine is identical because the pressure in the air chamber consists of the pressure of the liquid column in it and the pressure of the upper airspace of the air chamber 20.

The water in the lower part of air chamber 20 oscillates back and forth in accordance with the round arrows shown along the oscillation paths 208 and 210 between the air chamber 20 and the jigging chamber 15. The resonance frequency of the moving mass of water in the jigging chamber 15 and the air chamber 20 is in the magnitude of the excitation frequency of the loading of the air chamber 20 with air pressure. From the renowned theory of a forced oscillation it is known that the resonance frequency with higher oscillating masses sinks with a constant reset force (in this case gravity) and increases with lower oscillating masses. Furthermore, the resonance frequency of the oscillating mass of water decreases with increasing absorption, in this case that of the dissipation of the kinetic energy of the oscillating mass of water by the separating process. Because the mass of water in the system is in a stationary condition, the resonance frequency of the moving mass of water depends on the absorption by the separation rate in the jigging bed 152. The theory of forced oscillation also states that the phase of the oscillator almost coincides with the phase of the exciter with excitation frequencies smaller than the resonance frequency and when approaching the resonance frequency the phase of the exciter races ahead of the phase of the oscillator. Because the jigging machine 10 is operated in such a manner that the periodic loading of the air chamber 20 with pressurized air varies the level of liquid 151 below, but near to the resonance frequency, the phases of the moving mass of water changes in relationship to the loading with pressurized air with changes of the absorption.

In the mass of water moving between the air chamber 20 and the jigging chamber 15 a differential pressure precisely when the sum of the air pressure in the air chamber 20 and the column of water in the air chamber 20 does not coincide with the pressure of the water columns in the jigging chamber. This occurs precisely when the oscillating mass of water is not in phase with the air pressure in the air space of the air chamber 20. This is always the case during operation. Because the phasing in the vicinity of the resonance frequency varies greatly with the absorption, a deviation of the jigging machine is readily detectable by measuring the differential pressure between the air chamber and the jigging chamber, if a change in the jigging bed 152 induces changes in the absorption. If a deviation of the jigging machine 10 is detected by a disruption in the jigging bed 152, the disruption can be counteracted by means of a control strategy stored in the control unit.

The time-dependent differential pressure between the air chamber 20 and the jigging chamber 15 and the associated magnitudes have been shown in the signal chart in the right of FIG. 1. Signal chart a) shows the open state of the air input valve 40 over time. Corresponding to the opening of the air input valve 40, the pressure in the airspace of air chamber 20 increases, as shown in signal chart b), whereby the increased pressure decreases exponentially with time, as a consequence of the increasingly lower difference in the pressure between air-pressure tank 45 and the airspace in air chamber 20. With the increasing pressure in the airspace in the air chamber 20 the water is forced out of the air chamber 20 into the jigging chamber 15 as this is illustrated as pressure of the water column in the jigging chamber in signal chart c).

Due to the fact that the mass of water in the jigging chamber 15 and the air chamber 10 does not immediately follow the increasing pressure in the airspace in the air chamber 20 because of the mass inertia, initially a positive difference in pressure forms in which the pressure in the air chamber is greater than that of the jigging chamber 15. This is illustrated in the signal chart d). Only when the upper dead-point of the level of the liquid 151 is reached is a brief equilibrium attained where the differential pressure is zero. Harmonics cause a less than ideal line in signal chart d). After the air is released from the air chamber 20, whereby here too the inertia of the oscillating mass of water leads to the pressure in the air chamber 20 be lower than that in the jigging chamber 15. Only after an equilibrium is again attained does the differential pressure return to zero and a new cycle commences.

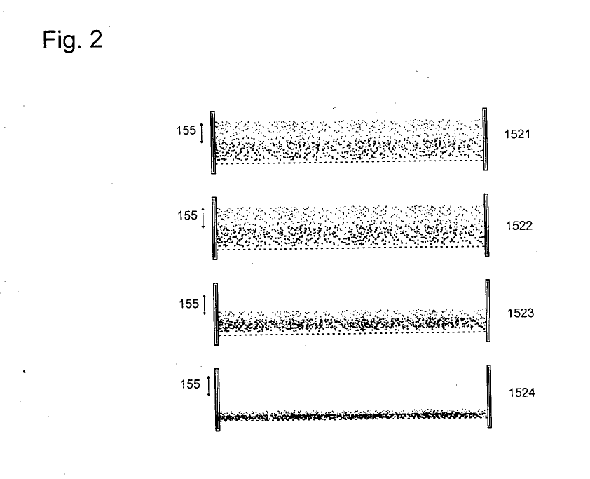

FIG. 2 shows different conditions of a jigging bed 152. The blacker points represent a separating substance with a higher density and the lighter points a substance with a lower density. The top jig bed 1521 represents an ideally adjusted jig bed 152 during the operation of the jigging machine 10. The level of the liquid 151 varies according to the stroke 155 shown on the left. The less dense grains and the denser grains of the substance to be separated are in different heights within the jigging bed 152 and can be drained off through drains in different heights. The dissipation of energy through the separation of the various dense fractions changes with the various separation phases until the dissipation reaches a maximum in the so-called dead-bed, shown as jig bed 1524. With external disturbances, for instance, because of the change of the grading or a change of the amount of substance to be separated, the mass to be moved through the jig bed is also altered. The phasing changes and as a consequence the differential pressure within the phase also changes.

When establishing a controlling strategy the exact understanding of the cause and effect relationship between the jig bed and the phasing is not of primary import. More importantly, the measurement of the differential pressure serves as an indicator for a disturbance of the jig bed 152. If a oneoff adjustment of the jigging machine is known, the expected course of the differential pressure can be stored with a predictive model and the planned-actual deviation during the operation of the jigging machine followed with the control 300 for the loading with air. A deviation of the differential pressure from that of the predictive model in the automatic control 300 is cause for changing the air input times.

It has been shown that a disturbance in the jig bed can be counteracted in the following manner. If the differential pressure being measured drops below the pressure calculated in the predictive model at the measuring time, the air input time is extended. By contrast, the air input time is shortened if the differential pressure being measured exceeds the pressure calculated in the predictive model at the measuring time.

To suppress artifacts in the measurement of the differential pressure caused by harmonics, it is intended to damp the differential pressure, so that the intensity of the damping is varied synchronously with the stroke frequency of the level of liquidity in the jigging machine. With the variation of the damping, an effect is achieved that behaves similarly to a lock-in amplifier. Consequently, the higher frequency portions will be more readily suppressed compared with the excitation frequency from the measured signal. By contrast, the signal with the frequency of the excitation will be favored and amplified compared to the disruptive artifacts.

If the measurement data of the absolute pressure are also available, it is then advantageous if the air input time then begins at the earliest when the difference from the absolute pressure in the air chamber is at the end of a previous cycle and the current pressure in the air chamber is zero. In this air is prevented from being collected in the air chamber for a number of cycles, because the air chamber 20 is not relieved of the volume of air that is injected when air is let in. With the collection of the air in the air chamber 20, there is a jet when air escapes from the air chamber 20 into the jigging chamber 15 and this disturbs the jig bed 152.

If the measurement data are also available, then it is also advantageous if the air input time is then terminated at the latest when the difference from the absolute pressure in the air chamber 20 at the end of a previous cycle and the current pressure in the air chamber have exceeded a predetermined threshold value. This hinders the air chamber 20 from overfilling, which also results in a jet of air.

Along with the main components, the differential pressure during the operation of the jigging machine also indicates higher frequency pressure rates. If the higher frequency rates are detected and exceed a predetermined portion of the total signal, this could be a sign of the formation of undesired resonance. It has proven advantageous for the regulation strategy if the frequency of the air input is then reduced if a frequency rate is detected in the course of the differential pressure whose rate exceeds a predetermined value and whose frequency is greater than the frequency of the air input.

A special case occurs if the differential pressure again increases after termination of the air input. This renewed increase may be an indication that the fraction in motion in the jig bed are collecting on the sieve 60. The jig bed 152 begins to die. Consequently, the water column in the jig bed 152 becomes lighter because the weight of the substance to be separated is now being held by the sieve 60 and is no longer being taken up by the water column, therefore creating a differential pressure. In this case, the frequency of the air input then increases, if after the termination of the air input the differential pressure exceeds a predetermined threshold value.

To measure the differential pressure between the jig chamber 15 and the air chamber 20, the pressure in the air chamber 20 can be measured in the water or the air. The measurement of the pressure in the air in the air chamber 20 has the advantage that the changes of phases can be better detected, whereby the resolution of the measurement method is improved and good control results attained. The measurement of the pressure in the water in the air chamber 20, on the other hand, has the advantage that artifacts in the measurement caused by standing waves in the jig bed 152 can at least partially be compensated. This means that the signal quality of the measured differential pressure is better.

The method presented here for controlling a jigging machine is suitable for the separation of coal and mine waste or for the separation of iron ore from silicate impurities.

List of Reference Numerals

| | |
|---|---|
| 10 | Jigging machine |
| 100 | Line |
| 110 | Differential pressure meter |
| 120 | Line |
| 15 | Jigging chamber |
| 151 | Level of liquid |
| 152 | jig bed |
| 155 | Hub |
| 20 | Air chamber |
| 201 | Level of liquid |
| 205 | Stroke |
| 208 | Oscillation path |
| 210 | Oscillation path |
| 25 | Tin |
| 30 | Air input |
| 35 | Air pressure line |
| 40 | Valve |
| 45 | Air pressure tank |
| 50 | Valve |
| 60 | Sieve |

What is claimed is:

1. A method for controlling a liquid stroke of a pneumatically driven jigging machine for separation of mineral blends, whereas the jigging machine comprises an air chamber and a jig with a jig bed arranged above the air chamber and whereas the stroke of the liquid used in the jigging machine is dependent on an air inlet time into the air chamber, the method comprising the following steps:
measuring a differential pressure between a pressure in the air chamber and a pressure in a liquid column in the jigging machine; and
controlling the air inlet time against the measured differential pressure.

2. The method according to claim 1, wherein the pressure is measured in the air chamber in a vicinity of the liquid or in a vicinity of the air inlet.

3. The method according to claim 1, wherein time points for the air inlet time are determined by a predictive model of a progression of the differential pressure, and wherein a deviation from the predictive model is a cause to alter the air inlet time.

4. The method according to claim 3, wherein the air inlet time is prolonged if the measured differential pressure falls below a pressure calculated by the predictive model at a measurement point in time, and wherein the air inlet time is shortened if the measured differential pressure exceeds the pressure calculated by the predictive model at the measurement point in time.

5. The method according to claim 1, wherein the measured differential pressure is damped in a time domain, wherein a damping intensity is varied synchronously with a stroke frequency of the liquid level in the jigging machine.

6. The method according to claim 1, wherein the air inlet time begins at earliest, when a difference between an absolute pressure in the air chamber at the end of a previous cycle and a current pressure in the air chamber is zero.

7. The method according to claim 1, wherein the air inlet time ends at the latest, when a difference between an absolute pressure in the air chamber at the end of a previous cycle and a current pressure in the air chamber exceeds a predetermined threshold value.

8. The method according to claim 1, wherein a frequency of the air inlet is reduced, if a frequency component in a temporal progression of the differential pressure is detected, said component exceeding a predetermined value and having a frequency that is higher than the frequency of the air inlet.

9. The method according to claim 1, wherein a frequency of the air inlet is increased, if after termination of the air inlet the differential pressure exceeds a predetermined value.
